(19) United States
(12) Patent Application Publication
(10) Pub. No.: US 2026/0260964 A1
(43) Pub. Date: Sep. 3, 2026

(54) BATTERY PACK AND TEMPERATURE CONTROL METHOD

(71) Applicant: ZHEJIANG JINKO ENERGY STORAGE CO., LTD., Haining City (CN)

(72) Inventor: Muyu LIU, Haining (CN)

(21) Appl. No.: 18/952,958

(22) Filed: Nov. 19, 2024

(30) Foreign Application Priority Data
Oct. 31, 2024 (CN) 202411536107.8

(51) Int. Cl. H01M 10/6567; H01M 10/613; H01M 10/6554

(52) U.S. Cl. CPC H01M 10/6567; H01M 10/613; H01M 10/6554

(57) ABSTRACT

Provided are a battery pack and a temperature control method. The battery pack includes cells, a box including an accommodating cavity provided with a heat exchange medium and provided with a liquid inlet and a liquid outlet, a support assembly provided in the accommodating cavity and including includes a support plate and a support member, and a lifting assembly. The support plate is capable of abutting against the support member and dividing the accommodating cavity to be a first cavity and a second cavity. The cells are arranged at the support plate and located in the first cavity. The lifting assembly drives the support plate to move to switch between a low-position state in which the support plate abuts against the support member and a high-position state in which a gap is formed between the support plate and the support member to reduce power consumption for heat dissipation.

### CROSS-REFERENCE TO RELATED APPLICATIONS

The present application claims priority to Chinese Application No. 202411536107.8, filed on Oct. 31, 2024, the content of which is incorporated herein by reference in its entirety.

### TECHNICAL FIELD

The present disclosure relates to the technical field of energy storage, and in particular, to a battery pack and a temperature control method.

### BACKGROUND

Batteries are common electrical energy storage devices. In order to meet a requirement for higher power, in the prior art, a plurality of batteries are generally combined to form a battery pack for operation. The batteries may generate heat during charging or discharging. If the heat is not controlled, the batteries may have a shortened service life or even be subjected to thermal runaway. In order to control operating temperatures of the batteries, there is a need to provide an external cooling system to dissipate the heat. According to a liquid cooling technology used in the prior art, the batteries are immersed in coolant, but the cooling system has quite high power consumption, which is not conducive to overall energy saving of the battery pack.

### SUMMARY

In view of this, the present disclosure provides a battery pack and a temperature control method.

An embodiment of the present disclosure provides a battery pack, including: cells; a box including an accommodating cavity and provided with a liquid inlet and a liquid outlet, the accommodating cavity being provided with a heat exchange medium; a support assembly provided in the accommodating cavity and including a support plate and a support member, the support plate being capable of abutting against the support member, the support plate being capable of dividing the accommodating cavity to be a first cavity and a second cavity along a height direction of the box, the first cavity being located above the second cavity, and the cells being arrange on the support plate and located in the first cavity; and a lifting assembly connected to the support plate and configured to drive the support plate to move along a height direction of the battery pack to switch between a low-position state and a high-position state. When the support plate is in the low-position state, the support plate abuts against the support member, and the first cavity and the second cavity are closed relative to each other; and when the support plate is in the high-position state, a gap is formed between the support plate and the support member, and the first cavity and the second cavity are in communication with each other.

According to the battery pack provided in embodiments of the present disclosure, a position state of the support plate can be adjusted according to an actual cooling requirement of the battery pack. When the battery pack has a lower heat dissipation requirement, the support plate is set to a low-position state, which can meet the heat dissipation requirement of the battery pack with less power consumption. When the battery pack has a higher heat dissipation requirement, the support plate is set to a high-position state, which improves heat dissipation efficiency of the battery pack and can also meet an actual heat dissipation requirement of the battery pack. The support assembly can also finely adjust a lifting height of the support plate to control a size of a gap between the support plate and the support member, which achieves more precise balance adjustment between cooling power consumption and cooling efficiency of the battery pack and helps reduce power consumption of the battery pack during the cooling.

In a possible implementation, the support plate includes heat dissipation holes, the heat dissipation holes are arranged corresponding to the cells, and projections of the cells along the height direction of the battery pack overlap with projections of the heat dissipation holes along the height direction of the battery pack.

In a possible implementation, a cross-sectional area of one of the heat dissipation holes decreases along a direction towards a corresponding cell of the cells.

In a possible implementation, the support plate includes at least one pressure equalizing hole, and a projection of the at least one pressure equalizing hole along the height direction of the battery pack does not overlap with the support member.

In a possible implementation, a projection area of the support plate along the height direction of the battery pack is smaller than a projection area of a bottom wall of the box along the height direction of the battery pack, and a projection of the support assembly along the height direction of the battery pack overlaps with a projection of the bottom wall of the box along the height direction of the battery pack.

In a possible implementation, the lifting assembly includes a driving member and a lifting member, the driving member is capable of driving the lifting member to move along the height direction of the battery pack, and the lifting member is connected to the support plate.

In a possible implementation, the battery pack further includes a partition plate. The partition plate is mounted at the support plate and located in the first cavity, an end of the partition plate is connected to a side wall of the box and another end of the partition plate forms a gap with another side wall of the box, and the liquid inlet and the liquid outlet are located at two sides of the partition plate.

An embodiment of the present disclosure provides a temperature control method, including: detecting temperatures of respective measuring points, to obtain measuring point temperatures; calculating an average temperature of the battery pack according to the measuring point temperatures in the battery pack; calculating a difference between each of the measuring point temperatures and the average temperature according to the average temperature, to obtain temperature differences of the measuring points; calculating a maximum temperature difference according to a maximum temperature and a minimum temperature in the measuring point temperatures; and adjusting a position state of the support plate of the battery pack according to the maximum temperature difference and the temperature differences.

In a possible implementation, the adjusting a position state of the support plate of the battery pack according to the maximum temperature difference and the temperature differences includes: adjusting the support plate of a corresponding battery pack to a high-position state when one of the temperature differences is greater than or equal to a first temperature threshold; adjusting the support plate of a corresponding battery pack to a high-position state when each of all the temperature differences is less than the first temperature threshold and the maximum temperature difference is greater than or equal to a second temperature threshold; and adjusting the support plate of a corresponding battery pack to a low-position state when each of all the temperature differences is less than a first temperature threshold and the maximum temperature difference is less than a second temperature threshold.

In a possible implementation, subsequent to adjusting a position state of the support plate of the battery pack according to the maximum temperature difference and the temperature differences, the method further includes: detecting a number of battery packs in which the support plates are in the high-position state and a number of battery packs in which the support plates are in the low-position state, respectively; increasing cooling power of a liquid cooler when the number of the battery packs in which the support plates are in the high-position state is greater than the number of the battery packs in which the support plates are in the low-position state; keeping the cooling power of the liquid cooler unchanged when the number of the battery packs in which the support plates are in the high-position state is less than or equal to the number of the battery packs in which the support plates are in the low-position state while the support plate in at least one of the battery packs is in the high-position state; and reducing the cooling power of the liquid cooler when the support plates of all the battery packs are in the low-position state.

### BRIEF DESCRIPTION OF DRAWINGS

In order to better illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a schematic diagram of an internal structure of a battery pack according to some embodiments of the present disclosure;

FIG. 2 is a sectional view of a battery pack according to some embodiments of the present disclosure;

FIG. 3 is a schematic structural diagram of a support plate according to some embodiments of the present disclosure;

FIG. 4 is a schematic structural diagram of a support plate mounted inside a box according to some embodiments of the present disclosure;

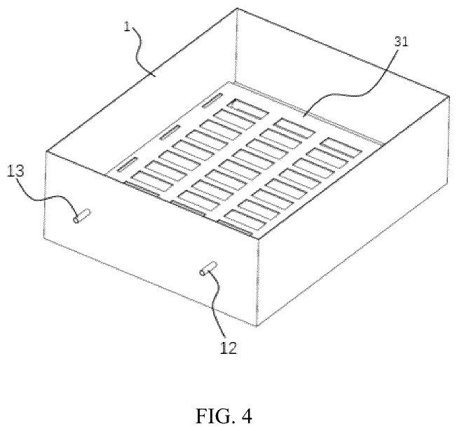

FIG. 5 is a schematic structural diagram of a support member according to some embodiments of the present disclosure;

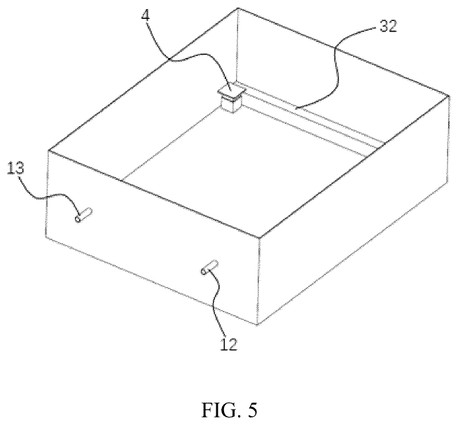

FIG. 6 is a partial sectional view of a battery pack according to some embodiments of the present disclosure;

FIG. 7 is a schematic structural diagram of a partition plate according to some embodiments of the present disclosure;

FIG. 8 is a schematic structural diagram of a battery pack according to some other embodiments of the present disclosure; and

FIG. 9 is a schematic flowchart of a temperature control method according to some embodiments of the present disclosure.

### REFERENCE SIGNS

1: box
11: accommodating cavity
111: first cavity
112: second cavity
12: liquid inlet
13: liquid outlet
2: cell
3: support assembly
31: support plate
311: heat dissipation hole
312: pressure equalizing hole
32: support member
4: lifting assembly
41: driving member
42: lifting member
5: partition plate
51: spacer

### DESCRIPTION OF EMBODIMENTS

For better illustrating the technical solution of the present disclosure, embodiments of the present disclosure will be described in detail below with reference to the accompanying drawings.

It should be clear that the described embodiments are only some of, rather than all of the embodiments of the present disclosure. Based on the embodiments in the present disclosure, all other embodiments obtained by those of ordinary skill in the art without creative efforts fall within a scope of the present disclosure.

The terms used in the embodiments of the present disclosure are for the purpose of describing particular embodiments only, and are not intended to limit the present disclosure. As used in the embodiments of the present disclosure and the appended claims, the singular forms of “a” and “the” may also include plural forms, unless otherwise clearly indicated in the context.

It should be understood that the term “and/or” used herein merely describes an association relationship between associated objects and indicates that three relationships may exist. For example, A and/or B may indicate the following three cases: only A exists, both A and B exist, and only B exists. In addition, the character “/” generally indicates an “or” relationship between the associated objects.

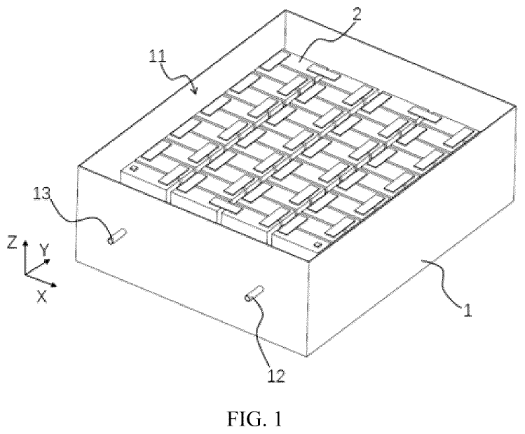

As shown in FIG. 1, some embodiments of the present disclosure provide a battery pack. The battery pack includes a box 1. The box 1 includes an accommodating cavity 11. A plurality of cells 2 are provided inside the box 1. The box 1 is provided with a liquid inlet 12 and a liquid outlet 13, and the accommodating cavity 11 is provided with a heat exchange medium. The heat exchange medium may be a fluid. For example, the heat exchange medium may be a liquid that can flow. The heat exchange medium can enter the accommodating cavity 11 from the liquid inlet 12 and be discharged from the accommodating cavity 11 from the liquid outlet 13, thereby realizing flow of the heat exchange medium inside the accommodating cavity 11. The liquid inlet 12 and the liquid outlet 13 may be connected to another external device, such as a water pump, to provide power for circulation of the flow of the heat exchange medium. By means of the circulating flow of the heat exchange medium, heat generated by the cells 2 during operation can be taken away, thereby improving safety of the battery pack and prolonging the service life of the battery pack.

When the heat exchange medium flows in the accommodating cavity 11, a temperature inside the accommodating cavity 11 can be adjusted, and in particular, the heat generated by the cells 2 during operation can be taken away, so that the cell 2 remains safe and has higher operating efficiency. In addition, the entire accommodating cavity 11 may be fully filled with the heat exchange medium, so that the entire cells 2 are entirely immersed in the heat exchange medium, thereby improving heat dissipation efficiency. The heat exchange medium should be an insulating material. When the heat exchange medium comes into contact with the cells 2, a short circuit may not occur in the cells 2, thereby improving overall safety of the battery pack. When the temperature of the battery pack is excessively high and needs to be lowered, the heat exchange medium is used to take away the heat. When the temperature of the battery pack is excessively low and needs to be increased, the battery pack may also be heated by the heat exchange medium so that the battery pack reaches an appropriate operation temperature. For example, when the battery pack operates in an environment at a low temperature, the battery at a lower temperature may be heated by providing a heat exchange medium at a high temperature. It should be understood that heat exchange described in the present disclosure refers to cooling and/or heating the battery pack. Some of the embodiments in the present disclosure are described by taking examples of cooling or heating. Both heating and cooling perform heat exchanging by circulating the heat exchange medium inside the box, thus principles for performing heating and cooling are similar to each other. Therefore, when one situation is described, the other situation may not be described again.

A support assembly 3 and a lifting assembly 4 are provided inside the accommodating cavity 11. The support assembly 3 includes a support plate 31 and a support member 32. The support plate 31 may be in a form of a flat plate, thereby providing a larger support area for arranging a plurality of cells 2. The lifting assembly 4 is connected to the support plate 31. The lifting assembly 4 can drive the support plate 31 to move along a height direction of the battery pack. As shown in FIG. 1, a direction X is a length direction of the battery pack, a direction Y is a width direction of the battery pack, and a direction Z is the height direction of the battery pack. Along the height direction of the battery pack, the support member 32 is located at a bottom of the support plate 31, and the support plate 31 can abut against the support member 32 to support the support plate 31, so the support plate 31 does not directly contact a bottom wall of the box 1. The support plate 31 can divide the accommodating cavity 11 into a first cavity 111 and a second cavity 112. Along the height direction of the battery pack, the first cavity 111 is located above the second cavity 112. The cell 2 is provided on the support plate 31 and located in the first cavity 111. When the lifting assembly 4 drives the support plate 31 to move, the support plate 31 can drive the cell 2 to move synchronously.

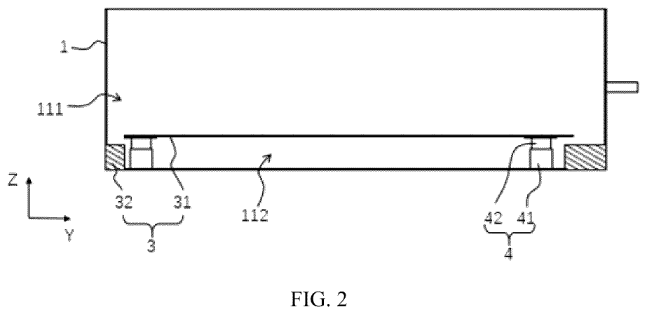

As shown in FIG. 2, the lifting assembly 4 can drive the support plate 31 to switch between a high-position state and a low-position state. When the support plate 31 is in the low-position state, the support plate 31 abuts against the support member 32, and no gap exists between the support plate 31 and the support member 32, so that the first cavity 111 and the second cavity 112 are closed relative to each other. The heat exchange medium has a fast flow speed and a fast circulation speed in the first cavity 111, the heat exchange medium does not flow and circulate in the second cavity 112, or the heat exchange medium flows and circulates at a very slow speed in the second cavity 112, so as to achieve lower flow resistance of the heat exchange medium in the accommodating cavity 11, which helps circulate the heat exchange medium through the liquid inlet 12 and the liquid outlet 13, so that power consumption required for the circulation of the heat exchange medium is kept low, thereby helping reduce the power consumption of the battery pack for cooling. For example, power consumption required for operation of a water pump or a valve connected to the liquid inlet 12 and the liquid outlet 13 can be reduced. When the support plate 31 is in the high-position state, the support plate 31 and the support member 32 are separated from each other and a gap is formed therebetween, the first cavity 111 and the second cavity 112 are in communication with each other, and the heat exchange medium in the first cavity 111 and the heat exchange medium in the second cavity 112 can flow and circulate, which increases a range and a volume of exchange of the heat exchange medium, thereby improving heat dissipation efficiency of the battery pack. According to the battery pack provided in embodiments of the present disclosure, a position state of the support plate 31 can be adjusted according to an actual cooling requirement of the battery pack. When the battery pack has a lower heat dissipation requirement, the support plate 31 is set to the low-position state, which can meet the heat dissipation requirement of the battery pack with less power consumption. When the battery pack has a higher heat dissipation requirement, the support plate 31 is set to a high-position state, which improves heat dissipation efficiency of the battery pack and can also meet an actual heat dissipation requirement of the battery pack. The support assembly 3 can finely adjust a lifting height of the support plate 31 to control a size of a gap formed between the support plate 31 and the support member 32, which achieves more precise balance adjustment between cooling power consumption and cooling efficiency of the battery pack, helps reduce power consumption of the battery pack during the cooling, and achieves overall energy saving of the battery pack. The battery pack may be provided with a sensor to monitor an operating temperature of the cell 2. By arranging electronic components, the position of the support plate 31 may be automatically controlled based on the monitored temperature, or may be manually controlled.

The lifting assembly 4 can drive the support plate 31 to move linearly along the height direction of the battery pack, or can drive the support plate 31 to move along the height direction of the battery pack and rotate, as long as the first cavity 111 and the second cavity 112 can be in communication with each other. The support member 32 may be in a shape extending along a length direction or a width direction of the battery pack, so that the support member 32 can provide a larger support area for supporting the support plate 31, thereby improving stability of the support plate 31. As shown in FIG. 1, the box 1 is generally formed as a shape of a polyhedron, such as a cuboid or a cube. In order to facilitate showing an internal structure of the battery pack, a top cover of the box 1 is omitted and not shown in FIG. 1. The bottom wall of the box 1 is flat, which facilitates placement and mounting of the battery pack. It should be understood that the relative closure of the first cavity 111 and the second cavity 112 may not be complete closure in the strict sense. Due to errors in size or flatness between the support plate 31 and the support member 32, the support plate 31 may be incapable of achieving a complete sealing effect when abutting against the support member 32. A certain tiny gap may still exist between the support plate 31 and the support member 32, so the heat exchange medium can pass therethrough, but this gap does not affect a separation effect of the support plate 31. The first cavity 111 and the second cavity 112 are generally relatively separated from each other. In this case, the heat exchange medium in the first cavity 111 and the second cavity 112 is at a very low exchange speed, the heat exchange medium mainly circulates and flows in the first cavity 111, and the heat exchange medium in the second cavity 112 flows and circulates very slowly.

The box 1 may be provided with a plurality of liquid inlets 12 and liquid outlets 13. For example, the first cavity 111 and the second cavity 112 are each provided with the liquid inlet 12 and the liquid outlet 13, thereby achieving faster circulation of the heat exchange medium. When the battery pack has a lower heat dissipation requirement, the support plate 31 may be set to the low-position state, the liquid inlet 12 and the liquid outlet 13 in communication with the second cavity 112 are closed, or operating efficiency thereof is reduced, and only the liquid inlet 12 and the liquid outlet 13 in communication with the first cavity 111 are opened for circulation of the heat exchange medium, thereby reducing power consumption required for cooling. When the battery pack has a higher heat dissipation requirement, the support plate 31 is set to the high-position state, and all the liquid inlets 12 and the liquid outlets 13 are opened for operation, thereby improving heat dissipation power.

Alternatively, the box 1 may be provided with only one liquid inlet 12 and only one liquid outlet 13, which helps reduce heat dissipation power consumption, simplify the structure of the battery pack, and reduce manufacturing costs. When the support plate 31 is in the high-position state, the first cavity 111 and the second cavity 112 are in communication with each other, and circulation of the heat exchange medium in the two cavities can be realized only by one liquid inlet 12 and one liquid outlet 13. When the support plate 31 is in the low-position state, according to the positions of the liquid inlet 12 and the liquid outlet 13, the circulation of the heat exchange medium only in the first cavity 111 or only in the second cavity 112 is performed, thereby reducing flow resistance and reducing power consumption.

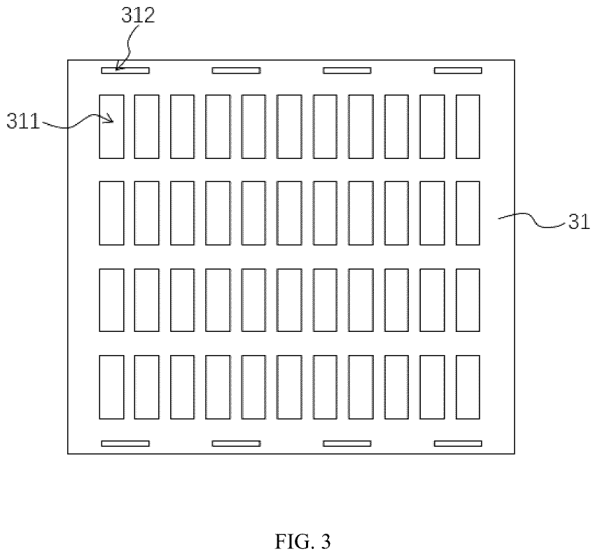

As shown in FIG. 3, in some embodiments, the support plate 31 includes a plurality of heat dissipation holes 311, the heat dissipation holes 311 are arranged corresponding to the cells 2, and projections of the cells 2 along the height direction of the battery pack overlaps with projections of the heat dissipation holes 311 along the height direction of the battery pack.

When the cell 2 is provided on the support plate 31, the heat dissipation hole 311 is located at the bottom of the cell 2, and the heat exchange medium in the second cavity 112 can contact a bottom wall of the cell 2 through the heat dissipation hole 311, thereby improving a cooling effect on the battery. The heat dissipation hole 311 may be formed as a shape such as a circle, an oval, or a square, which is not limited herein. The bottom of the cell 2 should cover the heat dissipation hole 311, so as to maximize a heat exchange effect of the heat dissipation hole 311 in the cell 2. One heat dissipation hole 311 or a plurality of heat dissipation holes 311 may be provided at the bottom of a same cell 2.

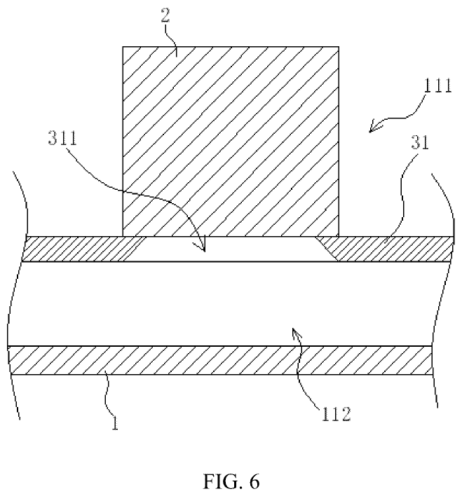

As shown in FIG. 6, in some embodiments, a cross-sectional area of the heat dissipation hole 311 in the height direction Z of the battery pack gradually decreases along a direction towards the cell 2.

A cross-sectional shape of the heat dissipation hole 311 may be formed as a tapered shape. Along the height direction of the battery pack, a cross-sectional area of the opening at a side of the heat dissipation hole 311 close to the cell 2 is smaller than a cross-sectional area of an opening at a side of the heat dissipation hole 311 away from the cell 2. The heat exchange medium in the second cavity 112 may contact the bottom of the cell 2 through the heat dissipation hole 311 to take away the heat of the cell 2, thereby improving heat dissipation efficiency of the cell 2. Since the support plate 31 has a certain thickness, the heat dissipation hole 311 may be regarded as a tubular channel having a small length. The cross-sectional area of the heat dissipation hole 311 is different at different positions along the height direction of the cell 2. For example, the cross-sectional area of the heat dissipation hole 311 gradually decreases along the direction towards the cell 2. The inner wall of the heat dissipation hole 311 may be formed as an inclined shape, or a stair-step shape to achieve changing in the cross-sectional area of the through hole. According to the basic principle of fluid mechanics, when the heat exchange medium flows towards the cell 2 through the heat dissipation hole 311, a flow speed thereof is accelerated due to the changing in the cross-sectional area of the heat dissipation hole 311, which can further enhance the heat dissipation effect of the cell 2.

In some embodiments, the support plate 31 has a pressure equalizing hole 312, and a projection of the pressure equalizing hole 312 along the height direction of the battery pack does not overlap with the support member 32.

When switching between the high-position state and the low-position state, the support plate 31 moves along the height direction of the battery pack. Due to the heat exchange medium inside the accommodating cavity 11, the support plate 31 may be subjected to resistance during movement. Through the arrangement of the pressure equalizing hole 312, an effect of communicating the first cavity 111 and the second cavity 112 can be achieved, which achieves a pressure balance, reduces resistance of the support plate 31 during movement, helps reduce the power consumption when the support plate 31 is driven, and facilitates increasing a movement speed of the support plate 31, thereby reducing the time required for the support plate 31 to switch between the high-position state and the low-position state. The pressure equalizing hole 312 may be provided at an edge of the support plate 31 to avoid the support member 32, so that when the support plate 31 is in the low-position state and abuts against the support member 32, the pressure equalizing hole 312 is not closed by the support member 32. The support plate 31 may be provided with a plurality of pressure equalizing holes 312. The plurality of pressure equalizing holes 312 are provided at two sides of the support plate 31, respectively, thereby improving an effect of reducing flow resistance. The pressure equalizing hole 312 may be formed as a shape of a rectangle or a circle, which is not limited herein.

In some embodiments, a projection area of the support plate 31 along the height direction of the battery pack is smaller than a projection area of a bottom wall of the box 1 along the height direction of the battery pack, and a projection of the support assembly 3 along the height direction of the battery pack overlaps with a projection of the bottom wall of the box 1 along the height direction of the battery pack.

The support plate 31 may be formed in a form of a flat plate, which facilitates the support for the cell 2 and the division of the accommodating cavity 11. An area of the support plate 31 may be slightly smaller than an area of the bottom wall of the box 1, so the projection area of the support plate 31 along the height direction of the battery pack is smaller than a projection area of a bottom wall of the box 1 along the height direction of the battery pack. As a result, a gap exists between the support plate 31 and at least one side wall of the box 1, to facilitate the communication between the first cavity 111 and the second cavity 112 when the support plate 31 and the support member 32 are separated from each other. The support member 32 may be arranged at a position where the projection of the bottom wall of the box 1 does not overlap with a projection of the support plate 31, and a projection of the support member 32 covers a part where the projection of the bottom wall of the box 1 does not overlap with the projection of the support plate 31. Therefore, when the support plate 31 is at the low-position state, the support plate 31 abuts against and fits the support member 32 to achieve relative closure of the first cavity 111 and the second cavity 112.

In some embodiments, the liquid inlet 12 and the liquid outlet 13 are in communication with the first cavity 111.

The liquid inlet 12 and the liquid outlet 13 are provided at an outer wall of the box 1 corresponding to the first cavity 111, so that the heat exchange medium in the first cavity 111 can circulate faster. Since the cell 2 is provided in the first cavity 111, heat dissipation efficiency of the cell 2 can be improved. When the support plate 31 is in the high-position state, the first cavity 111 and the second cavity 112 are in communication with each other, and the liquid inlet 12 and the liquid outlet 13 can directly exchange and circulate the heat exchange medium in the first cavity 111. Since the heat exchange media in the first cavity 111 and the second cavity 112 can flow to each other, the flow in the second cavity 112 can be indirectly realized. When the support plate 31 is in the low-position state, the first cavity 111 and the second cavity 112 are closed relative to each other, the liquid inlet 12 and the liquid outlet 13 circulate and exchange the heat exchange medium in the first cavity 111, and the heat exchange medium in the second cavity 112 can be regarded as non-flow exchange or circulate at an extremely slow speed, thereby greatly reducing the resistance of the heat exchange medium during the flowing and reducing the power consumption of the battery pack for cooling and heat dissipation.

In some embodiments, the support assembly 3 includes two support members 32, and the two support members 32 are located at two sides of the support plate 31, respectively.

The support members 32 may be provided at two sides of the support plate 31 along a length direction and a width direction of the battery pack, thereby improving stability of the support plate 31. Alternatively, the battery pack may be provided with a plurality of support members 32 to support the support plate 31 at a middle position of the support plate 31.

As shown in FIG. 2, in some embodiments, the lifting assembly 4 includes a driving member 41 and a lifting member 42, the driving member 41 can drive the lifting member 42 to move along the height direction of the battery pack, and the lifting member 42 is connected to the support plate 31.

The lifting member 42 includes an end connected to the driving member 41 and another end connected to the support plate 31. When the driving member 41 drives the lifting member 42 to move along the height direction of the battery pack, the support plate 31 can move together with the lifting member 42 to switch between the high-position state and the low-position state. A side of the lifting member 42 connected to the support plate 31 may be formed as a flat surface, which can improve stability of the connection between the lifting member 42 and the support plate 31. The driving member 41 and the lifting member 42 may be connected to each other by a rack, a pulley, or the like, which is not limited herein. The battery pack may be provided with a plurality of lifting assemblies 4. For example, support assemblies 3 may be provided at corners of the support plate 31 respectively, so as to increase a speed and improve stability of the support plate 31 during the movement, and reduce resistance of the flow of the heat exchange medium in the second cavity.

In some embodiments, the heat exchange medium may be formed by one of mineral oil, vegetable oil, silicone oil, or synthetic oil.

The heat exchange medium should be fluid and insulating, which can improve the heat dissipation efficiency through flow circulation without affecting safety of operation of a circuit in the battery pack. The mineral oil may be a mixture of compounds such as alkanes, naphthenic saturated hydrocarbons, and aromatic unsaturated hydrocarbons, such as transformer oil. The vegetable oil may be castor oil, linseed oil, tung oil, or the like. The synthetic oil is oil refined from ethylene and propylene dispersed from crude oil gas or natural gas through reactions such as polymerization and catalysis. The synthetic oil has excellent properties through artificial control. The silicone oil is insulating silicone oil, such as methyl silicone oil. Due to a high density of a variety of insulating oil, the corresponding flow resistance during the circulation is also large. According to the battery pack provided in the embodiments of the present disclosure, the position of the support plate 31 may be controlled to change a circulation flow range of the heat exchange medium inside the accommodating cavity 11, to control the flow resistance of the heat exchange medium inside the accommodating cavity 11. When the battery pack has a low heat dissipation requirement, a circulation range and flow resistance of the heat exchange medium in the accommodating cavity 11 are reduced, to achieve an effect of saving energy consumption.

In some embodiments, the bottom wall of the box 1 may be provided with a flow guide plate, and the flow guide plate protrudes along the height direction of the battery pack to form a flow channel. By arranging a plurality of flow guide channels, a flow channel is formed in the second cavity 112 to guide the flowing of the heat exchange medium. The flow guide plate may cause the heat exchange medium to produce a turbulent effect, disrupting the stratosphere where the heat exchange medium is in contact with the bottom of the cell 2, so that a flow layer far away from the bottom of the cell 2 can also receive more heat, thereby improving the heat dissipation efficiency.

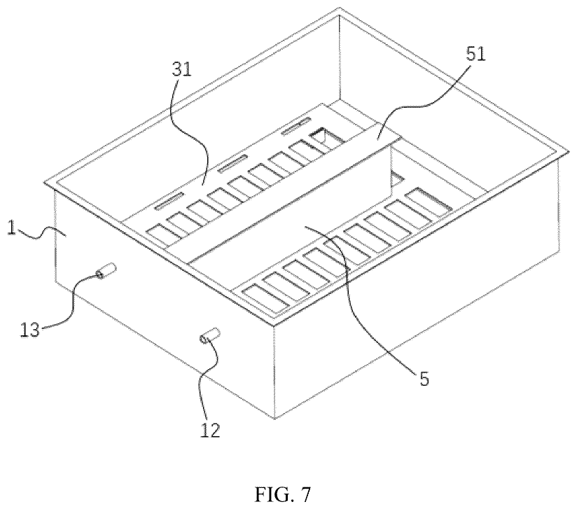

As shown in FIG. 7, in some embodiments, the battery pack includes a partition plate 5, the partition plate 5 is mounted on the support plate 31 and located in the first cavity 111, the partition plate 5 includes an end connected to a side wall of the box 1 and another end forming a gap with another side wall of the box 1, and the liquid inlet 12 and the liquid outlet 13 are located at two sides of the partition plate 5.

The liquid inlet 12 and the liquid outlet 13 at the box 1 may be provided at a same side wall of the box 1, and a position where the partition plate 5 is connected to the side wall of the box 1 is located between the liquid inlet 12 and the liquid outlet 13. Therefore, the partition plate 5 can separate the liquid inlet 12 from the liquid outlet 13, and the other end of the partition plate 5 is not connected to the box 1. Therefore, the heat exchange medium can flow around the partition plate 5. When the support plate 31 is in the high-position state, the top of the partition plate 5 can abut against a top wall of the box 1, the heat exchange medium is injected into the box 1 through the liquid inlet 12, and the heat exchange medium needs to bypass a side surface of the partition plate 5 to reach the liquid outlet 13 for discharge, so that a flow path of the heat exchange medium becomes a curve, which increases a flow distance and a flow range of the heat exchange medium and reduces a flow dead zone, thereby improving the heat exchange efficiency. A height of the partition plate 5 is configured with reference to a height of the cell 2. The height of the partition plate 5 should be the same as the height of the cell 2 or slightly higher than the height of the cell 2, so as to leave sufficient space for arrangement of the cell 2 and can abut against the top wall of the box 1. In order to facilitate showing the internal structure of the box 1, the top wall of the box 1 is not shown in the figure, and the top wall of the box 1 plays a sealing role. The battery pack may change the shape of the flow channel by providing a plurality of partition plates 5. Connection positions of the plurality of partition plates 5 are respectively located at two opposite side walls of the box 1, to form a serpentine-like flow channel. A flow path of the heat exchange medium includes a plurality of bending sections, thereby further increasing the flow range of the heat exchange medium and improving a heat exchange effect.

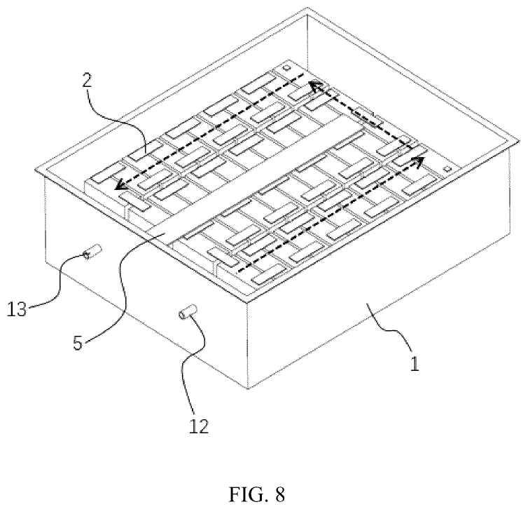

As shown in FIG. 7 and FIG. 8, in some embodiments, a spacer 51 is provided at a side of the partition plate 5 away from the support plate 31, and the spacer 51 is parallel to the support plate 31. When the support plate 31 is in the high-position state, the spacer 51 abuts against the top wall of the box 1.

The spacer 51 and the partition plate 5 are arranged perpendicular to each other, and are connected to each other to form a roughly “T” shape. The spacer 51 can increase a contact area between the partition plate 5 and the top wall of the box 1, thereby improving sealing performance of the partition plate 5 and reducing a possibility of the heat exchange medium flowing from a seal position.

When the support plate 31 is in the high-position state, there is a preset distance between the battery pack and the top wall of the box 1 in the height direction, and the preset distance is similar or equal to the height of the partition plate 5. Therefore, when the support plate 31 is in the high-position state, the support plate 31 can abut against the top wall of the box 1, to realize a partitioning function and form a flow channel. As shown in FIG. 8, the black dotted arrow in the figure is a schematic direction of the flow of the heat exchange medium, and the shape of the flow channel is similar to a “U” shape, which extends the flow distance of the heat exchange medium and increases the flow range of the heat exchange medium, thereby improving the heat exchange effect. The partition plate 5 and the spacer 51 can move together with the support plate 31. When the support plate 31 switches between the high-position state and the low-position state, the partition plate 5 can switch between two states of separating the first cavity 111 to form a flow channel and releasing the separation.

When the support plate 31 is in the high-position state, the partition plate 5 and the spacer 51 can move together with the movement of the support plate 31 to abut against the top wall of the box 1, to divide the flow channel of the first cavity 111 into two parts connected to each other to form a flow channel, and the heat exchange medium can circulate along the flow channel to increase the flow range of the heat exchange medium. Further, the support plate 31 and the support member 32 are separated from each other, and the first cavity 111 and the second cavity 112 are in communication with each other. Therefore, when the support plate 31 is in the high-position state, the heat exchange medium can have a larger circulation space and a larger flow distance in the box 1, thereby achieving a stronger heat exchange capacity and meeting a higher heat exchange requirement in actual operation.

When the support plate 31 is in the low-position state, the partition plate 5 and the spacer 51 connected to the support plate 31 may move together with the support plate 31 to be a lower position. Therefore, the partition plate 5 and the spacer 51 may be separated from the top wall of box 1, and the heat exchange medium can flow relatively freely inside the box 1, thereby reducing flow resistance, which further cooperate with the support plate 31 to divide the entire box 1 into an upper part and a lower part, thereby reducing the flow range of the heat exchange medium, so energy consumption required for thermal management of the battery pack is reduced.

The support plate 31 can switch between the high-position state and the low-position state, so the heat exchange efficiency and the power consumption for thermal management can be flexibly adjusted to meet different actual requirements. When the battery pack has a lower heat exchange requirement, the support plate 31 is adjusted to the low-position state, which reduces the power consumption for thermal management, thereby reducing the overall power consumption of the battery pack. When the battery pack has a higher lower heat exchange requirement, the support plate 31 is adjusted to the high-position state, which increases the flow range of the heat exchange medium and meets an actual heat exchange requirement.

Some embodiments of the present disclosure provide an energy storage container. The energy storage container includes an inverter, a battery management system, and at least one battery pack. The battery pack is the battery pack as described in any one of the above embodiments. The energy storage container may be provided with a circulation driving apparatus to drive the flow of the heat exchange medium. The circulation driving apparatus is connected to the liquid inlet 12 and the liquid outlet 13.

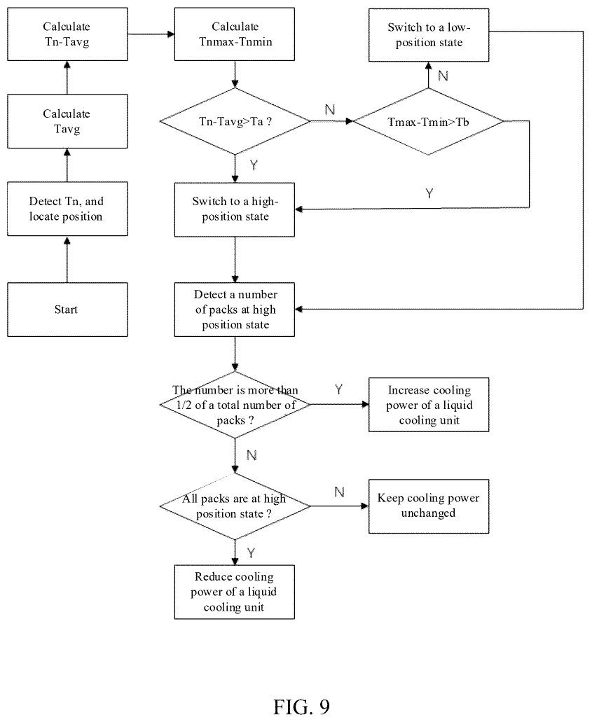

As shown in FIG. 9, some embodiments of the present disclosure provide a temperature control method. The temperature control method includes the following steps.

In S01, temperatures of respective measuring points are detected to obtain measuring point temperatures.

In S02, an average temperature of the battery pack is calculated according to the measuring point temperatures in the battery pack.

In S03, differences between the measuring point temperatures and the average temperature are calculated according to the average temperature to obtain temperature differences.

In S04, a maximum temperature difference is calculated according to a maximum temperature and a minimum temperature in the measuring point temperatures.

In S05, a position state of the support plate 31 of the battery pack is adjusted according to the maximum temperature difference and the temperature differences.

The temperature control method provided in the embodiments of the present disclosure is used to perform temperature control on an energy storage system, for example, an energy storage container. The energy storage container includes a plurality of battery packs. Each battery includes a plurality of cells 2. Measuring points are provided at surfaces of the cells. The measuring points at the surfaces of the cells 2 are provided with temperature sensors for detecting temperatures of the cells 2. For example, a temperature sensor may be provided for every 3 to 5 cells 2, and the temperature sensors can be arranged relatively evenly and consistently. The temperature sensor may be an NCT temperature sensor. A measuring point temperature Tn in the battery pack can be obtained by the temperature sensor. Tn denotes a temperature obtained by a certain temperature sensor. Temperature values obtained by a plurality of temperature sensors are respectively T1, T2, T3, and the like. An average temperature Tavg of a certain battery pack can be calculated through the measuring point temperatures Tn obtained by a plurality of temperature sensors. A calculation formula is: (T1+T2+. . . +Tn)/n=Tavg, where n is a positive integer greater than 0 and denotes a number of measuring points, and (T1+T2+. . . +Tn) denotes a sum of all the measuring point temperatures in the battery pack. The temperature difference refers to a difference between a certain measuring point temperature Tn and the average temperature Tavg, that is, Tn−Tavg. Each measuring point has a temperature difference. The maximum temperature Tnmax refers to a maximum value in all the measuring point temperatures Tn in a certain battery pack. The minimum temperature Tnmin refers to a minimum value in all the measuring point temperatures Tn in a certain battery pack. The maximum temperature difference is a difference between the maximum temperature Tnmax and the minimum temperature Tnmin, that is, Tnmax−Tnmin. The embodiments of the present disclosure are described taking adjustment of one battery pack as an example. The measuring point temperature, the temperature difference, the average temperature, and the maximum temperature difference mentioned above are data obtained in a same battery pack. The energy storage system includes a plurality of battery packs. The energy storage system can control and adjust the plurality of battery packs, respectively.

A current temperature of the battery pack can be determined by obtaining the maximum temperature difference and the temperature differences, thereby adjusting a position state of the support plate 31 of the battery pack according to the maximum temperature difference and the temperature differences and further adjusting heat dissipation efficiency and heat dissipation power consumption of the battery pack. The energy storage system is provided with a monitoring apparatus, which can monitor a current position state of the support plate 31 of each battery pack. For example, when it is determined that the battery pack requires higher heat dissipation power, the position of the support plate 31 is adjusted to the high-position state to enhance the heat dissipation capability of the battery pack. When it is determined that the battery pack requires lower heat dissipation power, the position of the support plate 31 is adjusted to the low-position state to reduce power consumption required for heat dissipation of the battery pack. The method provided in the embodiments of the present disclosure can accurately and reasonably detect and evaluate a temperature state of each battery pack, to determine a required state of the support plate 31, thereby achieving a balance between heat dissipation efficiency and power consumption, which helps control power consumption of a heat dissipation system.

In some embodiments, S05 of adjusting a position state of the support plate 31 of the battery pack according to the maximum temperature difference and the temperature differences includes the following steps.

In S051, the support plate 31 of the corresponding battery pack is adjusted to a high-position state when one of the temperature differences is greater than or equal to a first temperature threshold.

In S052, the support plate 31 of the corresponding battery pack is adjusted to the high-position state when each of all the temperature differences is less than the first temperature threshold and the maximum temperature difference is greater than or equal to a second temperature threshold.

In S053, the support plate 31 of the corresponding battery pack is adjusted to a low-position state when each of all the temperature differences is less than the first temperature threshold and the maximum temperature difference is less than the second temperature threshold.

The first temperature threshold Ta and the second temperature threshold Tb are temperature values preset by the energy storage system based on actual requirements and specifications of the energy storage system. By reasonably configuring the first temperature threshold and the second temperature threshold, the position and the state of the support plate 31 can be reasonably controlled. When Tn−Tavg≥Ta, indicating that a difference between a certain measuring point temperature Tn and the average temperature Tavg in the corresponding battery pack exceeds the first temperature threshold Ta, the support plate of the battery pack is adjusted to the high-position state. When Tn−Tavg<Ta and Tnmax−Tnmin≥Tb, indicating that the difference between any measuring point temperature Tn and the average temperature Tavg is less than the first temperature threshold Ta and the maximum temperature difference exceeds the second temperature threshold Tb, the position state of the support plate is further determined according to a relationship between the maximum temperature difference and the second temperature threshold Tb. According to the temperature control method provided in the embodiments, a current temperature state of the battery pack and required heat dissipation power can be accurately determined, and the heat dissipation power of the battery pack can be accurately adjusted.

In some embodiments, subsequent to adjusting a position state of the support plate 31 of the battery pack according to the maximum temperature difference and the temperature differences, the method further includes the following steps.

In S06, a number of battery packs in which the support plates are in the high-position state and a number of battery packs in which the support plates are in the low-position state are detected, respectively.

In S07, cooling power of a liquid cooler is increased when the number of the battery packs in which the support plates are in the high-position state is greater than the number of the battery packs in which the support plates are in the low-position state.

In S08, cooling power of a liquid cooler is kept unchanged when the number of the battery packs in which the support plates are in the high-position state is less than or equal to the number of the battery packs in which the support plates are in the low-position state while the support plate in at least one battery pack is in the high-position state.

In S09, cooling power of the liquid cooler is reduced when the support plates in all the battery packs are in the low-position state.

The energy storage system is provided therein with a liquid cooling unit. The liquid cooling unit is configured to exchange heat between the heat exchange medium in a liquid cooling loop, such as cooling the coolant. The liquid cooling unit is controlled by a battery management system. The liquid cooling unit has adjustable power and has at least three different cooling power gears to meet the adjustment of the power of the liquid cooling unit, which includes, for example, a first gear, a second gear, and a third gear in ascending order of power. A range of liquid cooling power and a number of gears can be reasonably set according to an operating environment and specifications of a cooling system, so that the energy storage system can be flexibly adjusted. By reasonably adjusting the power of the liquid cooling unit, a cooling requirement of the battery pack can be met in a timely manner, which keeps the energy storage system within an appropriate operating temperature range and can also reduce the overall cooling power consumption of the energy storage system.

The structure, features, and effects of the present disclosure are described in detail above according to the embodiments shown in the drawings. The above are only preferred embodiments of the present disclosure, and the present disclosure does not limit the scope of implementation as illustrated in the drawings. Any changes made in accordance with the conception of the present disclosure, or equivalent embodiments modified as equivalent changes, which still do not exceed the spirit covered by the specification and the drawings, shall fall within the protection scope of the present disclosure.

What is claimed is:

1. A battery pack, comprising:
cells;
a box comprising an accommodating cavity and provided with a liquid inlet and a liquid outlet, wherein the accommodating cavity is provided with a heat exchange medium;
a support assembly provided in the accommodating cavity and comprising a support plate and a support member, wherein the support plate is capable of abutting against the support member, the support plate is capable of dividing the accommodating cavity to be a first cavity and a second cavity along a height direction of the box, the first cavity is located above the second cavity, and the cells are arranged on the support plate and located in the first cavity; and
a lifting assembly connected to the support plate and configured to drive the support plate to move along a height direction of the battery pack to switch between a low-position state and a high-position state,
wherein when the support plate is in the low-position state, the support plate abuts against the support member, and the first cavity and the second cavity are closed relative to each other; and when the support plate is in the high-position state, a gap is formed between the support plate and the support member, and the first cavity and the second cavity are in communication with each other.

2. The battery pack according to claim 1, wherein the support plate is a flat plate.

3. The battery pack according to claim 1, wherein the lifting assembly is configured to drive the support plate to move linearly along the height direction of the battery pack, or drive the support plate to move along the height direction of the battery pack and rotate.

4. The battery pack according to claim 1, wherein the box is provided with a plurality of liquid inlets and a plurality of liquid outlets, and the first cavity and the second cavity each are provided with at least one liquid inlet and at least one liquid outlet.

5. The battery pack according to claim 1, wherein the support plate comprises heat dissipation holes, the heat dissipation holes are arranged corresponding to the cells, and projections of the cells along the height direction of the battery pack overlap with projections of the heat dissipation holes along the height direction of the battery pack.

6. The battery pack according to claim 5, wherein one of the heat dissipation holes is formed as a shape of a circle, an oval, or a square.

7. The battery pack according to claim 5, wherein one or more heat dissipation holes are provided at a bottom of one of the cells.

8. The battery pack according to claim 5, wherein a cross-sectional area of one of the heat dissipation holes decreases along a direction towards a corresponding cell of the cells.

9. The battery pack according to claim 5, wherein an inner wall of one of the heat dissipation holes may be formed as an inclined shape, or a stair-step shape.

10. The battery pack according to claim 1, wherein the support plate comprises at least one pressure equalizing hole, and a projection of the at least one pressure equalizing hole along the height direction of the battery pack does not overlap with the support member.

11. The battery pack according to claim 10, wherein the support plate is provided with a plurality of pressure equalizing holes, and the plurality of pressure equalizing holes are provided at two sides of the support plate.

12. The battery pack according to claim 10, wherein one of at least one pressure equalizing hole is formed as a shape of a rectangle or a circle.

13. The battery pack according to claim 1, wherein the support assembly comprises two support members, and the two support members are located at two sides of the support plate, respectively.

14. The battery pack according to claim 1, wherein a projection area of the support plate along the height direction of the battery pack is smaller than a projection area of a bottom wall of the box along the height direction of the battery pack, and a projection of the support assembly along the height direction of the battery pack overlaps with a projection of the bottom wall of the box along the height direction of the battery pack.

15. The battery pack according to claim 1, wherein the lifting assembly comprises a driving member and a lifting member, the driving member is capable of driving the lifting member to move along the height direction of the battery pack, and the lifting member is connected to the support plate.

16. The battery pack according to claim 1, wherein a bottom wall of the box is provided with a flow guide plate, and the flow guide plate protrudes along the height direction of the battery pack to form a flow channel; and the flow channel is formed by providing a plurality of flow guide channels in the second cavity, to guide flowing of the heat exchange medium.

17. The battery pack according to claim 1, further comprising a partition plate, wherein the partition plate is mounted at the support plate and located in the first cavity, an end of the partition plate is connected to a side wall of the box and another end of the partition plate forms a gap with another side wall of the box, and the liquid inlet and the liquid outlet are located at two sides of the partition plate.

18. The battery pack according to claim 17, wherein a position where the partition plate is connected to the side wall of the box is located between the liquid inlet and the liquid outlet, such that the partition plate separates the liquid inlet from the liquid outlet.

19. The battery pack according to claim 17, wherein a height of the partition plate is the same as a height of the cells or slightly higher than the height of the cells, such that a space is formed for arrangement of the cells and the partition plate is capable of abutting against a top wall of the box.

20. The battery pack according to claim 17, wherein a spacer is provided at a side of the partition plate away from the support plate, and the spacer is parallel to the support plate, such that when the support plate is in the high-position state, the spacer abuts against a top wall of the box.
